(19) United States
(12) Patent Application Publication
(10) Pub. No.: US 2012/0180713 A1
(43) Pub. Date: Jul. 19, 2012

(54) Aquatic Vegetation Removal Device and Method

(75) Inventors: Stephen Brent Cornwell, Lemont, IL (US); Alan Frederick Eberlein, Rockford, MI (US)

(73) Assignee: Accu-Labs, Inc., Chicago, IL (US)

(21) Appl. No.: 13/008,305

(22) Filed: Jan. 18, 2011

(51) Int. Cl. B63B 17/00; B63B 35/00; A01D 44/00

(52) U.S. Cl. 114/343; 56/8; 114/258

(57) ABSTRACT

A device for cutting aquatic vegetation is provided. In one embodiment, the device has a plurality of cutting blades that rotate freely on an elongate shaft and cut aquatic vegetation as the device travels through a body of water. In one approach, the device includes an impact accommodating mechanism that permits the device to absorb an impact between the device and submerged objects in the body of water. A method is also provided that includes providing an aquatic vehicle having disposed thereon a cutting device, the cutting device having a shaft with at least one cutting blade journaled for free rotation on the shaft. The vehicle is moved through a body of water to cause rotation of the cutting blade and cutting of aquatic vegetation in the body of water.

### FIELD

Embodiments of the invention are in the field of cutting, harvesting, or otherwise processing aquatic vegetation, and certain embodiments pertain to devices and methods of removing aquatic vegetation from bodies of water.

### BACKGROUND

Aquatic vegetation, such as weeds, may inhibit the use and enjoyment of ponds, lakes, rivers, inland streams, and other bodies of water. A number of approaches exist for controlling aquatic vegetation. One traditional approach of controlling aquatic vegetation utilizes a boat having an engine that drives a propeller mounted on the boat. The propeller is intended to cut aquatic vegetation as the boat travels through a body of water.

In many cases, the traditional propeller approach is ill-suited for operation at boat speeds in excess of trolling speeds. The aquatic vegetation may be relatively dense and can overwhelm the propeller. Also, the speed of the boat must be limited to accommodate the propeller striking a log, rock, or other solid object within the body of water, or the bottom of the body of water. The structures that connect the propeller to the boat sometimes are not built to withstand high-speed collisions between the propeller and objects within the body of water.

### SUMMARY

In accordance with one aspect, a device for removing aquatic vegetation has a plurality of cutting blades that rotate freely on an elongate shaft and cut aquatic vegetation as the device travels through a body of water. The cutting blades are journaled at coaxial spaced locations along the elongate shaft. The device is connectable to or connected to an aquatic vehicle. Surprisingly, the device can be fashioned to limit accumulation of aquatic vegetation on the cutting blades, thus permitting the device to be used at vehicle speeds substantially in excess of trolling speeds without overwhelming the cutting blades. There is no engine or motor driving the cutting blades that could be damaged by contact between the cutting blades and objects in the body of water. The device may be provided with one or more mechanisms that permit the device to accommodate an impact between the shaft or cutting blades and a submerged object at high boat speeds. Embodiments of the invention also encompass an aquatic vehicle having a hull and propulsion system and a cutting apparatus operably connected to the hull, the cutting apparatus being as described herein.

In some embodiments, the device has a plurality of shafts and at least one cutting blade journaled for free rotation on each shaft. The cutting blades spin freely on their respective shafts, and each cuts aquatic vegetation as the device travels through a body of water. The shafts may be mounted to a support that is removably connectable to or connected to an aquatic vehicle. Again, the device may be provided with one or more mechanisms to accommodate an impact between the support, shafts, or cutting blades and a submerged object at high boat speeds.

In another aspect, a method of cutting aquatic vegetation is provided. The method employs an aquatic vehicle that is provided with a cutting device and is operated at speeds higher than trolling speeds. The cutting device has a shaft with at least one cutting blade journaled for free rotation on the shaft. The vehicle is moved through a body of water to cause rotation of the cutting blade and cutting of aquatic vegetation in the body of water. In some embodiments, the aquatic vehicle can travel at boat speeds over ten miles per hour.

### BRIEF DESCRIPTION OF THE DRAWINGS

FIG. 1 is a side elevational view of an aquatic vehicle having disposed thereon an aquatic vegetation removal device in accordance with one embodiment of the invention showing the device in operation;

FIG. 2 is a perspective view of a portion of the aquatic vegetation removal device illustrated in FIG. 1;

FIG. 3 is front elevational view of a portion of the aquatic vegetation removal device illustrated in FIG. 1;

FIG. 4 is a front elevational view of a cutting blade of the aquatic vegetation removal device illustrated in FIG. 1;

FIGS. 5A and 5B are perspective views, enlarged with respect to FIG. 1, of a hinge and pin respectively of the aquatic vegetation removal device illustrated in FIG. 1;

FIG. 5C is an enlarged perspective view of a spring for use with an alternative embodiment of the aquatic vegetation removal device illustrated in FIG. 1;

FIG. 6 is a side elevational view of the aquatic vehicle and aquatic vegetation removal device illustrated in FIG. 1 showing the aquatic vegetation removal device after striking a submerged object;

FIG. 7A is an enlarged side elevational view of the aquatic vegetation removal device illustrated in FIG. 1, showing the pin in a broken state and the hinge in an open position.

FIG. 7B is an enlarged side elevational view similar to FIG. 7A but illustrating an alternative embodiment employing a hinge and spring, and showing the hinge and spring in open and distended positions respectively;

FIG. 8 is a perspective view of an aquatic vegetation removal device in accordance with another embodiment of the invention;

FIGS. 9 and 10 are side elevational and front elevational views of the aquatic vegetation removal device illustrated in FIG. 8 disposed on an aquatic vehicle;

FIG. 11 is a perspective view of an aquatic vegetation removal device in accordance with another embodiment of the invention; and

FIG. 12 is a side elevational view of the aquatic vegetation removal device illustrated in FIG. 11 disposed in a non-operating position on an aquatic vehicle.

Terms of orientation and relative size are intended solely for reference to the drawings herein, and are not intended to be limiting.

### DETAILED DESCRIPTION OF THE PREFERRED EMBODIMENTS

Generally, a cutting device is employed in connection with an aquatic vehicle. Any suitable aquatic vehicle may be employed, such as a closed or open boat, motorized sled, or the like. The vehicle may be provided with any suitable propulsion system, which may be, for example, a gasoline or diesel engine, electric motor, sails, or oars. The hull of the vehicle may be made from any material suitable for hulls, such as wood, fiberglass, steel, or other materials. The vehicle may utilize any suitable form of steering, such as wheel or tiller steering, and any suitable propulsion system, such as a propeller or jet drive. As illustrated and described herein, the cutting device is rigidly but removably connected directly to the hull of the vehicle while in use, but in other embodiments (not shown), the cutting device may be otherwise disposed. For instance, the cutting device may be mounted on a float that is towed behind the aquatic vehicle. In some embodiments, the cutting device may be permanently secured to the vehicle, with structurally integral connections between the device and the vehicle. In some embodiments, the invention encompasses a vegetation removal apparatus, and in other embodiments, the invention encompasses an aquatic vehicle equipped with a vegetation removal apparatus.

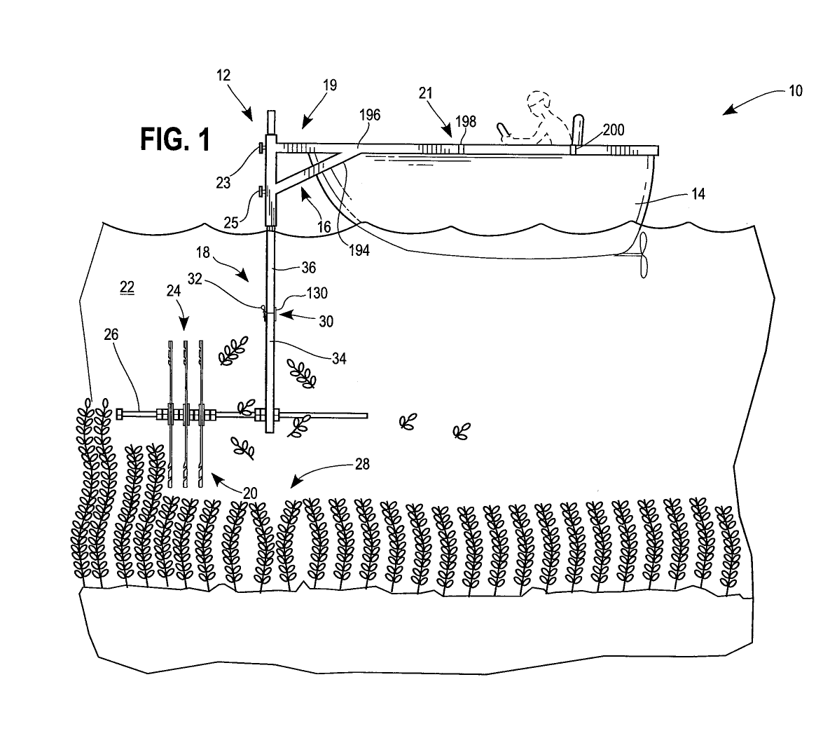

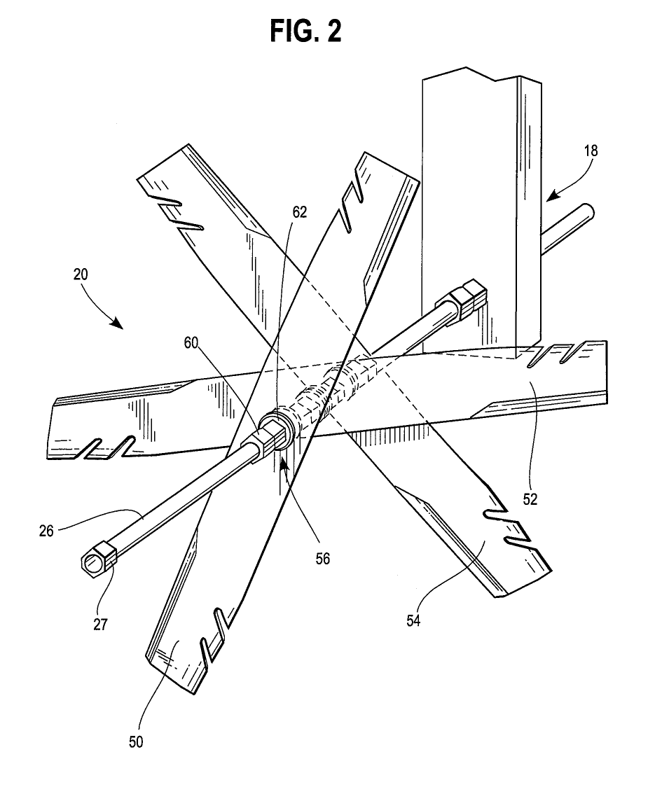

With reference to FIG. 1, the aquatic vegetation removal apparatus 10 comprises an aquatic vegetation removal device 12 mounted on an aquatic vehicle, which, in the illustrated embodiment, is an open boat 14 driven with a gas motor. The device 12 has a mounting structure 16 that includes a support 18 for positioning a cutting device 20 at a desired depth within a body of water 22. The cutting device 20 has an elongate shaft 26 fixed to the support 18, and a plurality of cutting blades 24 journaled for free rotation on the shaft 26. In this manner, as the boat 14 travels through the body of water 22, the plurality of blades 24 are free to rotate and cut aquatic vegetation 28 disposed within the body of water 22. The device 12 of FIG. 1 is shown with the shaft 26 protruding forward of the bow of the boat 14, but in other configurations the shaft 26 may protrude towards the stern. In the context of this application, free rotation connotes positioning of the blade for rotation without being directly driven by a motor or engine, although the propulsion of the aquatic vehicle indirectly may cause rotation of the blade via flow of water over the blade. The mounting structure 16, support 18, and shaft 26 may be, for example, made from steel, stainless steel, aluminum, aircraft aluminum, titanium, or combinations of those materials. In the illustrated embodiment, the elongate shaft 26 has an optional nut 27 (see FIG. 2) used to cover threads that may be present on the shaft 26.

The support 18 in the illustrated embodiment is composed of a lower portion 34, an upper portion 36, and an impact accommodating mechanism 30. In the illustrated embodiment, the impact accommodating mechanism 30 includes a hinge 130 and a safety member, such as a shear pin 32. As discussed in more detail hereinbelow, the hinge 130 permits the lower portion 34 of the support 18 to pivot relative to the upper portion 36 in the event the cutting device 20 strikes a submerged object. The mounting structure 16 comprises a frame 19 with a mount 21 for connection to the bow of the boat 14, the mounting structure 16 and support 18 cooperating to allow an operator to raise or lower the support 18 relative to the frame 19. The mounting structure 16 also includes adjustment screws 23, 25 for fixing the support 18 at a desired position relative to the frame 19. The frame 19 may comprise a beam 196 and a strut 194, and the mount 21 may comprise a pair of straps 198, 200.

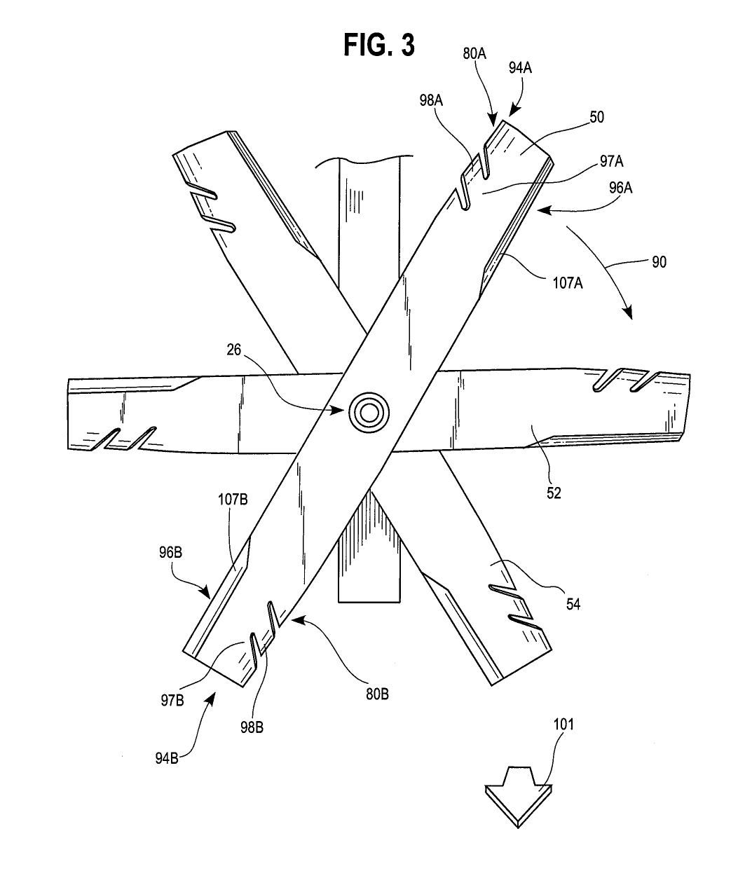

Turning to FIGS. 2 and 3, the cutting device 20 has a leading blade 50, an intermediate blade 52, and a trailing blade 54, each of which is mounted for free rotation on the shaft 26. The cutting blades 50, 52, 54 may be provided with a pitch or pitched region, such that the flow of water over the blades 50, 52, 54 biases the blades 50, 52, 54 for rotation in a manner analogous to a turbine blade. For example, in the illustrated embodiment, the cutting blade 50 has a pair of normally trailing portions 94A, 94B and a pair of normally leading portions 96A, 96B, as shown in FIG. 3. The normally trailing portions 94A, 94B include pitched regions 97A, 97B with fingers 98A, 98B formed by cutout and bent portions of the pitched regions 97A, 97B of the blade 50. As the blade 50 travels through water in a forward direction 101, the flow of water over the blade 50 causes the blade 50 to rotate in the direction of arrow 90. The normally leading portions 96A, 96B include cutting edges 107A, 107B for initially cutting aquatic vegetation. The normally trailing portions 94A, 94B include cutting edges 80A, 80B on the fingers 98A, 98B which further cut aquatic vegetation as the blade 50 rotates in direction 90. In this approach, the pitch of the cutting blades 50, 52, 54 is such that flow of water as the boat 14 travels in a reverse direction causes rotation of the blades 50, 52, 54 in a direction opposite direction 90. To permit the blades 50 to remove aquatic vegetation as the boat 14 travels in reverse, the normally trailing edges of the blade 50 may be provided with additional cutting edges opposite the cutting edges 107A, 107B of the leading portions 96A, 96B. In one approach, the cutting blades 50, 52, 54 are Gator Mulcher brand 20½ inch mulching blades.

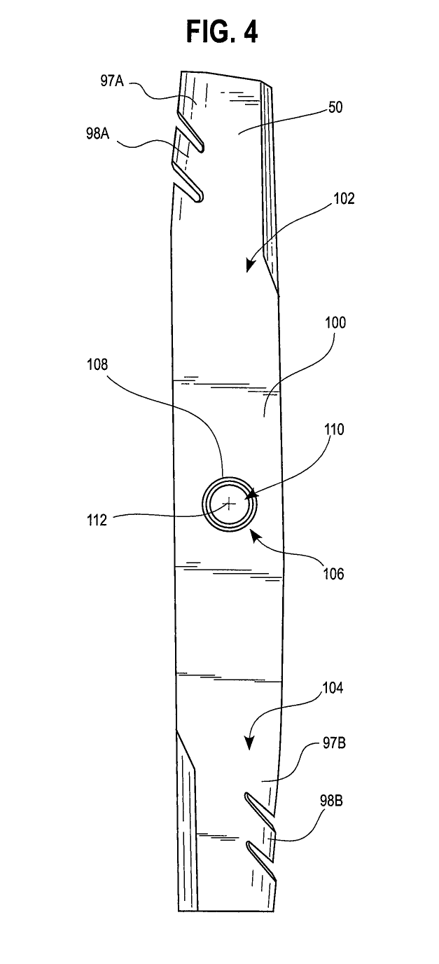

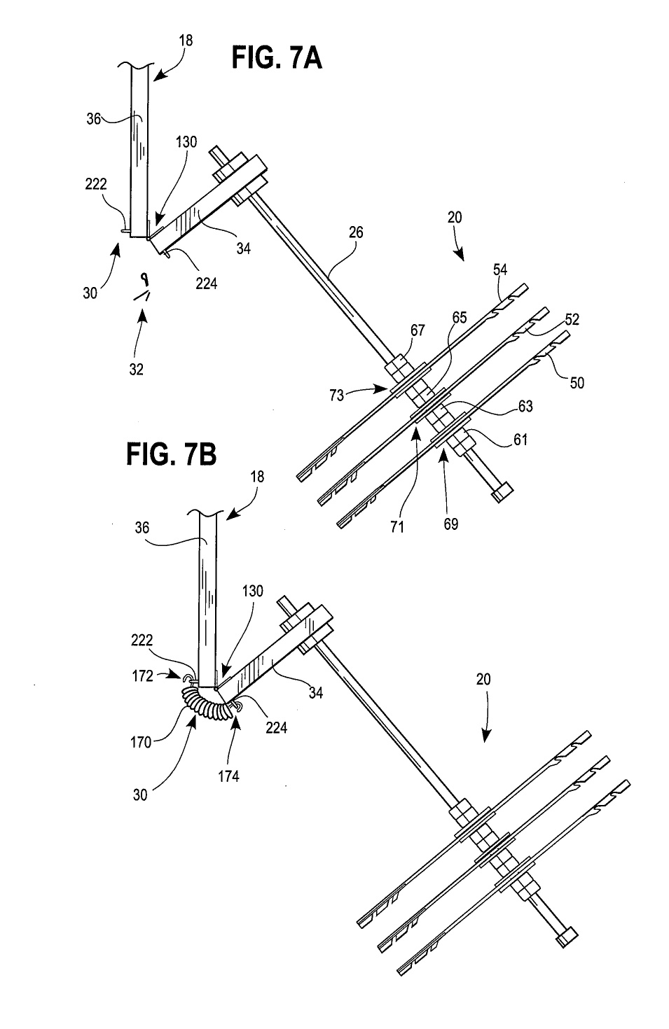

As seen in FIG. 4, cutting blade 50 has a mounting portion 100 generally in the center of the blade 50 with face portions 102, 104 extending away from the mounting portion 100. In the illustrated embodiment, the blades 50, 52, 54 are connected to the shaft via rotatable connections 56 (see FIG. 2) that each comprise a plurality of nuts 60 and washers 62 which hold the blades 50, 52, 54 on the shaft 26. In one approach, the rotatable connection 56 includes a ball bearing journal assembly 106 press-fit into an opening 108 in the mounting portion 100, as shown in FIG. 4. The ball bearing journal assembly 106 may be, for example, an SKF brand flange bearing, part no. RF 10-22-14-PP, having the following dimensions: ⅝ inch inner diameter, 1⅜ inch outer diameter, with a ¼ inch thickness. The ball bearing journal assembly 106 has bore 110 for receiving a portion of the shaft 26 therethrough. Further, the ball bearing assembly 106 has a center axis 112 that is aligned with center axes of similar bearing assemblies of the other blades 52, 54 when mounted on the shaft 26. More specifically, with reference to FIG. 7A, two pairs of nuts 61, 63 and a pair of washers 69 hold the blade 50 on the shaft 26, two pairs of nuts 63, 65 and a pair of washers 71 hold the blade 52 on the shaft 26, and two pairs of nuts 65, 67 and a pair of washers 73 hold the blade 54 on the shaft 26. The pairs of nuts 61, 63, 65, and 67 engage threaded portions of the shaft 26 and restrict axial movement of the blades 50, 52, 54 along the shaft 26. The pairs of washers 69, 71, 73 separate the ball bearing journal assemblies of the blades 50, 52, 54 from adjacent nuts 61, 63, 65, 67 and permit the blades 50, 52, 54 to freely rotate on the shaft 26.

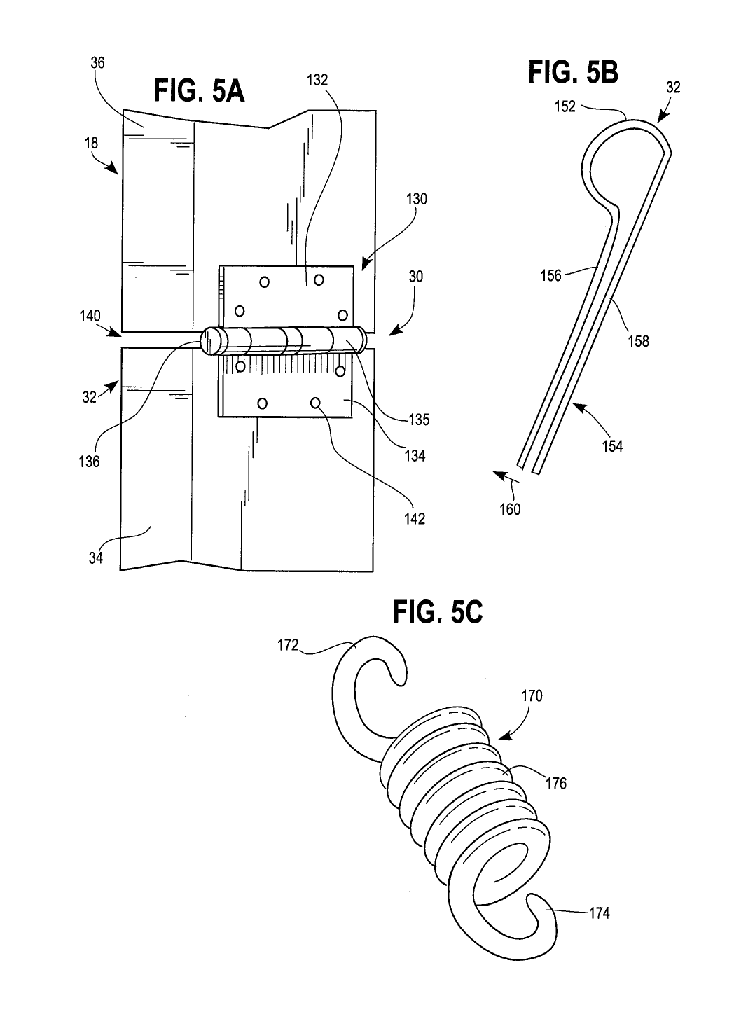

Turning to FIGS. 5A and 5B, and with further reference to FIG. 1, the impact accommodating mechanism 30 of the support 18 includes a hinge 130 and the shear pin 32, the hinge 130 being mounted on an opposite side of the support 18 from the shear pin 32 (FIG. 5B). The hinge 130 has a pair of leaves 132, 134 fixed respectively to the upper and lower portions 36, 34 via welds 142 or other suitable connections. The hinge 130 extends across a gap spacing 140 between the portions 34, 36, with the leaves 132, 134 joined at a knuckle 135 with a hinge pin 136. The shear pin 32 normally extends through a pair of aligned eyes 222, 224 (see FIG. 7A) mounted on the portions 34, 36 of the support 18 to fix the hinge 130 in the closed position, i.e., with the portions 34, 36 generally aligned in a normal operating position. The shear pin 32 is made from stainless steel, aluminum, or other rigid materials. As shown in FIG. 5B, the shear pin 32 has a head 152 with a rounded configuration and a tail 154 with a pair of straights 156, 158 for extending through the eyes 222, 224. The head 152 resiliently biases the straight 156 away from the straight 158 in direction 160 and contributes to the engagement between the shear pin 32 and the eye bolts 222, 224.

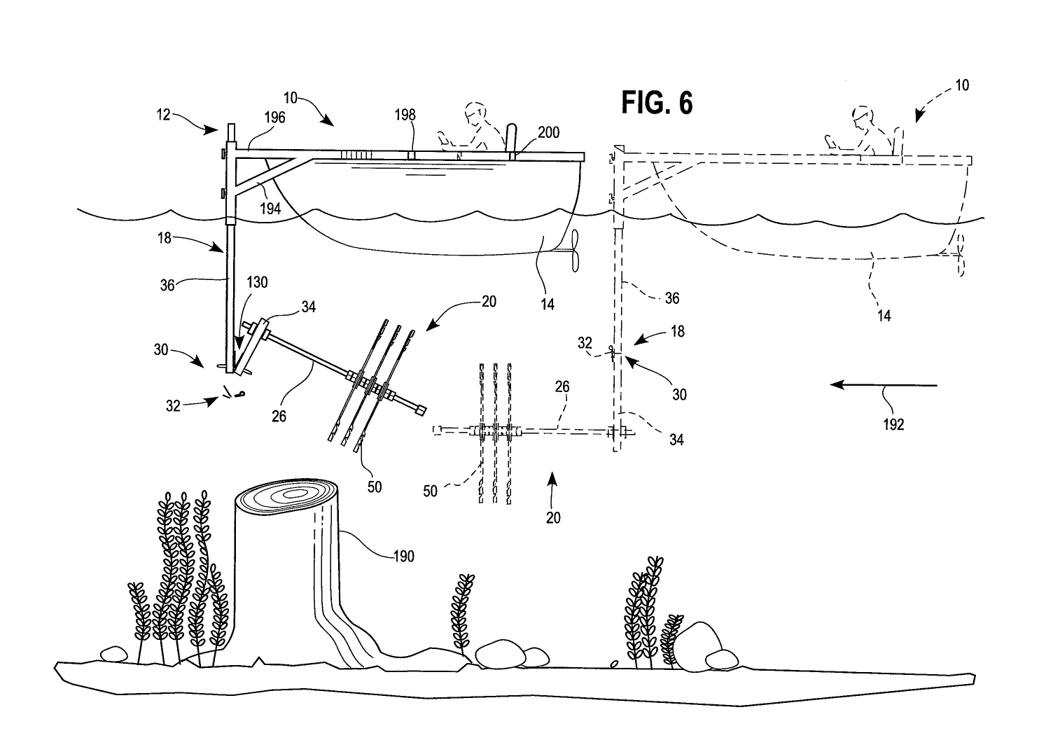

In FIG. 6, the apparatus 10 is shown after the apparatus 10 strikes a submerged object, such as a log 190, with the operating position of the apparatus 10 shown in hidden lines. Originally, the shear pin 32 fixes the upper portion 36 and the lower portion 34 of the support 18 relative to one another thus maintaining the cutting device 20 in an operating condition with the shaft 26 generally parallel to a direction of travel 192. When the cutting blade 50 strikes the log 190, the force of the impact causes the shear pin 32 to shear and causes the lower portion 34 to pivot relative to the upper portion 36, as further seen in FIG. 7A. The lower portion 34 may not pivot to the extent shown in FIG. 7A. To return the device to an operating position, the operator repositions the upper and lower portions 36, 34 and secures them with a new shear pin 32. The lower portion 34 may be provided with a retrieval lanyard (not shown) or other suitable device to assist the operator in resetting the cutting device 20.

In an alternative embodiment, the impact accommodating mechanism 30 is provided with a spring 170, as shown in FIG. 5C. The spring 170 has hooks 172, 174 that engage the upper and lower portions 36, 34 of the member 18, for instance, via eyes 222, 224. The spring 170 also has coils 176 with sufficient tensile strength to maintain the portions 34, 36 of the support 18 in an aligned configuration as the cutting device 20 removes aquatic vegetation. As seen in FIG. 7B, the spring 170 distends to permit the lower portion 34 to pivot away from the upper portion 36 if the cutting device 20 strikes a submerged object.

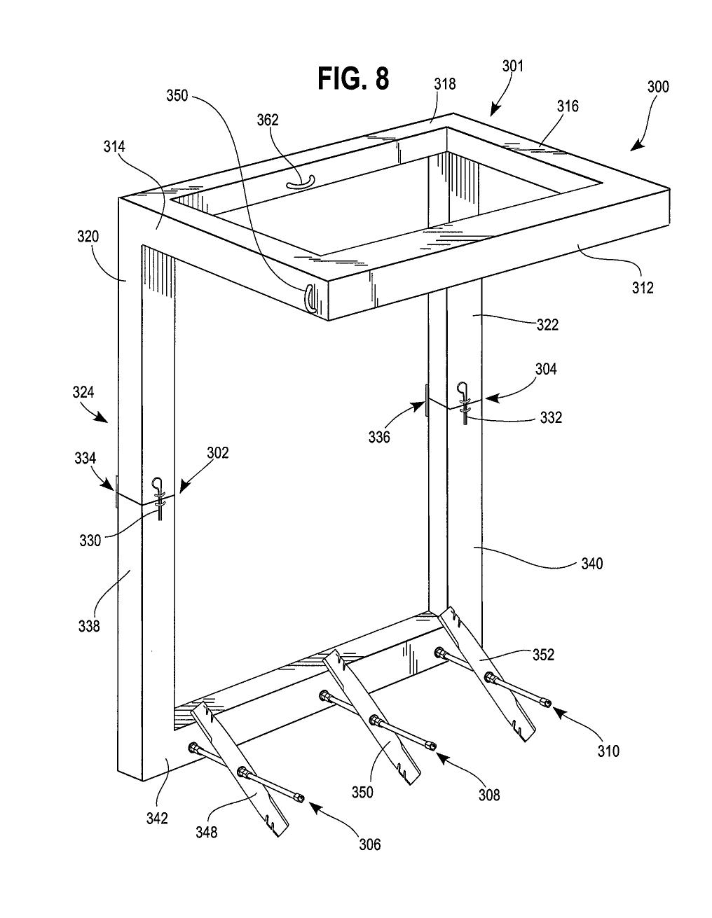

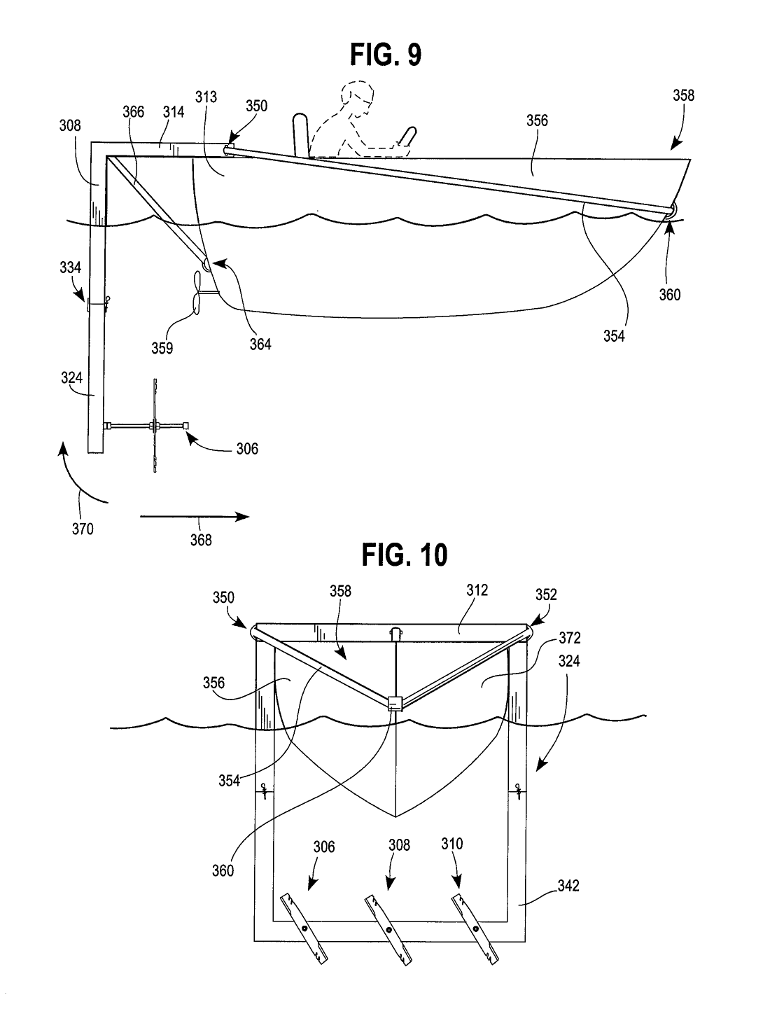

Turning to FIG. 8, the aquatic vegetation removal device 300 operates similarly to the device 12 of FIG. 1, except that the device 300 includes a frame 301 having a pair of impact accommodating mechanisms 302, 304 and three cutting devices 306, 308, 310 mounted to the frame 301. A cross member 312 of the frame 301 is positioned athwart a stern 313 of a boat 358 (shown in FIGS. 9 and 10). Extending away from the cross member 312 are a pair of arms 314, 316 having sufficient length to position the cutting devices 306, 308, 310 astern of an outward motor or other propulsion mechanism of the boat (e.g., propeller 359 in FIG. 9). The frame 301 may also have a cross member 318 that holds upper portions 320, 322 of a support 324 of the device 300 in a generally upright configuration. The support 324 includes a transverse member 342 extending between lower portions 338, 340 of the support 324 to which cutting devices 306, 308, 310 are mounted. Although the cutting devices 306, 308, 310 are illustrated with only a single cutting blade 348, 350, 352, it will be appreciated that each cutting device 306, 308, 310 may have two or more cutting blades. The blades may be configured as earlier described. The shafts alternatively may be independently connected (not shown) to an upper part of the device 300.

Like the device 12 described earlier, the device 300 is provided with impact accommodation mechanisms 302, 304 that include shear pins 330, 332 opposite hinges 334, 336 which permit the lower portions 338, 340 to pivot about the hinges 334, 336 in the event the support 324 and/or the cutting devices 306, 308, 310 strike a submerged object. In an alternative embodiment, the impact accommodating mechanisms 302, 304 have springs (not shown) similar to spring 170 rather than the shear pins 330, 332.

With reference to FIGS. 8-10, the device 300 has a pair of fore loops 350, 352 allowing connection of a strap 354 to secure the device 300 to the boat 358. In one approach, the strap 354 is fed through a trailer loop 360 on the hull 356. With reference to FIG. 10, the strap 354 extends between loops 350, 352, around a bow 372 of the boat 358, and through the trailer loop 360 on the bow 372. The device 300 also includes an aft loop 362 allowing connection of a strap 366 to secure the device 300 to an attachment point 364 on the stern of the hull 356, as shown in FIG. 9. As the boat 358 travels in a direction 368, drag on the device 300 from the water and the aquatic vegetation tends to urge the support 324 to travel in the direction of arrow 370, as shown in FIG. 9. The strap 366 tends to resist this rotation. Each strap 354, 366 may be adjustable, and the straps 354, 366 may include one or more winches (not shown) or other suitable devices for tightening the straps 354, 366 to the boat 358. The straps 354, 366 are preferably formed from natural or synthetic strapping fibers. In an alternative embodiment, cables, chains, or other devices may be used.

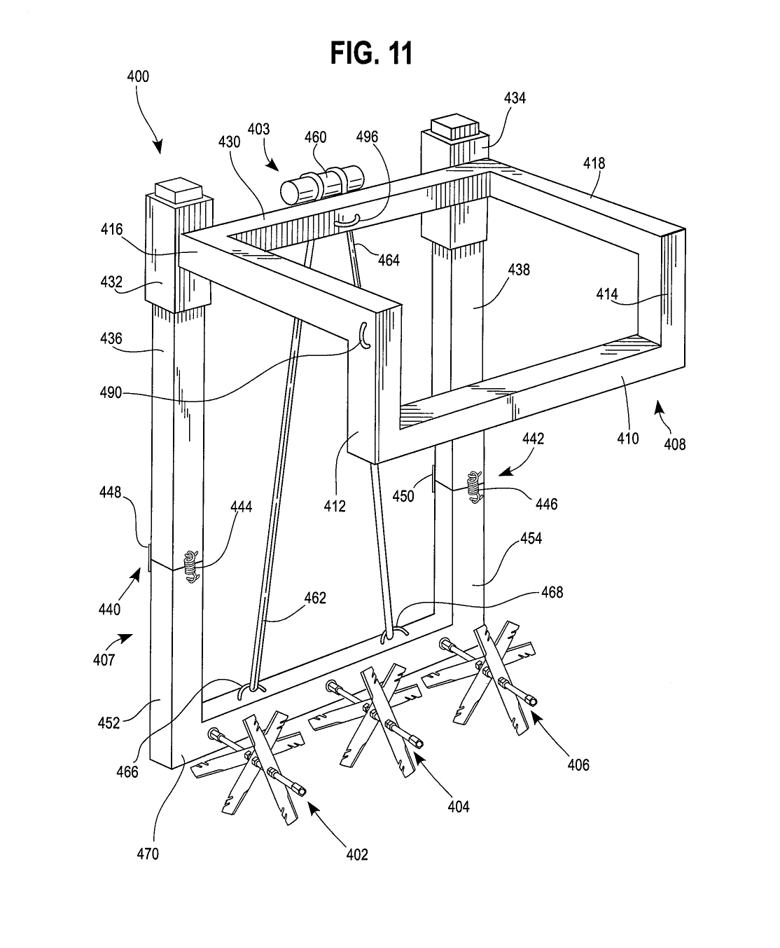

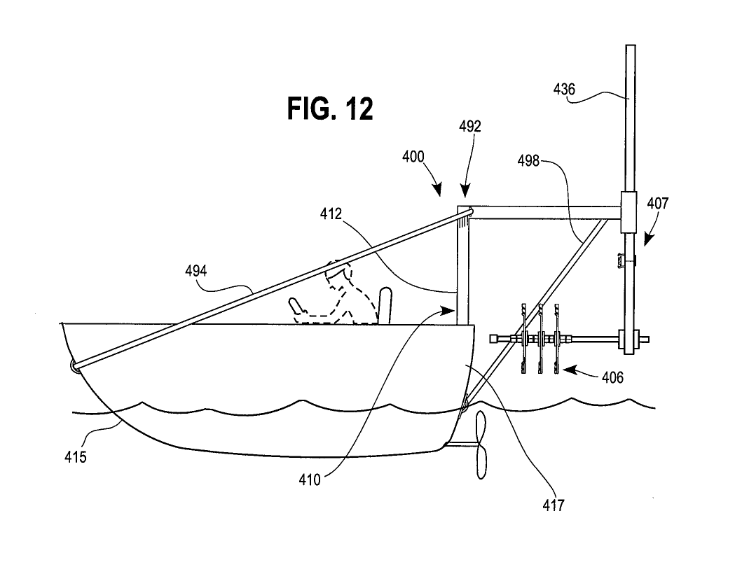

With reference now to FIG. 11, an aquatic vegetation removal device 400 has three cutting devices 402, 404, 406 mounted on a support 407, each cutting device having one or more cutting blades as heretofore described. The device 400 has a frame 408 that is normally fixed with respect to the hull of an aquatic vehicle. The device 400 is further provided with a lift 403 that allows the operator to raise or lower the support 407 relative to the frame 408. The support 407 and frame 408 are sized to permit the support 407 to move over a range of travel between a lowermost position (FIG. 11) where the cutting devices 402, 404, 406 are at their lowermost operating position, and an uppermost position (FIG. 12) where the cutting devices 402, 404, 406 are fully raised above the water.

The frame 408 includes a cross member 410 that extends athwart a stern 417 of a boat 415 (see FIG. 12) and a pair of riser members 412, 414 extending upward from the cross member 410 and sized to have a height that permits the cutting devices 402, 404, 406 to be raised out of the water when the support 407 has been raised to the uppermost position of FIG. 12. In some embodiments, the riser members 412, 414 may have a length of approximately three feet. The frame 408 has arms 416, 418 that extend away from the riser members 412, 414 a distance that is sufficient to position the support 407 and cutting devices 402, 404, 406 astern of an outboard motor or other propulsion device of the boat 415. In some embodiments, the arms 416, 418 may have a length of four to six feet.

A transverse member 430 extends between the arms 416, 418 and has sleeves 432, 434 for slidably receiving upper portions 436, 438 of the support 407. The device 400 has a pair of impact accommodating mechanisms 440, 442 including, respectively, springs 444, 446 mounted opposite hinges 448, 450. In a manner similar to that heretofore described, the hinges 448, 450 permit lower portions 452, 454 of the support 407 to pivot about the hinges 448, 450 in the event the transverse member 470 and/or the cutting devices 402, 404, 406 strike a submerged object. In an alternative embodiment, the impact accommodating mechanisms 440, 442 may include shear pins (not shown) similar to the shear pin 32.

In one approach, the lift 403 comprises a winch 460 mounted on the cross member 430 that allows an operator to raise and lower the support 407 relative to the frame 408. The winch 460 is connected to a pair of straps or cables 462, 464 that engage loops 466, 468 on the transverse member 470. Operation of the winch 460 draws the support 407 upwardly to a desired height, or releases the support 407 to drop downwardly to a desired depth. The winch 460 may include a locking mechanism to fix the support 407 at the desired height. In alternative embodiments, hydraulics, gears, pulleys, or other mechanisms may be used to raise and lower the support 407 instead of the winch 460. The device 400 has a pair of fore loops 490, 492 and an aft loop 496 for engaging straps 494, 498 in a manner similar to loops 350, 352 of the device 300.

For any of the devices described herein, the device is operated by propelling an aquatic vehicle through water that contains aquatic vegetation. The vehicle may be propelled at speeds in excess of the trolling speeds that are typical of the heretofore described prior devices. In some embodiments, the vehicle may be propelled at a speed of at least 10 mph; in other embodiments, a speed of at least 11 mph; in other embodiments, a speed of at least 12 mph; in other embodiments, a speed of at least 13 mph; in other embodiments, a speed of at least 14 mph; in other embodiments, a speed of at least 15 mph; in other embodiments, a speed of at least 16 mph; in other embodiments, a speed of at least 17 mph; in other embodiments, a speed of at least 18 mph; in other embodiments, a speed of at least 19 mph; in other embodiments, a speed of at least 20 mph; in other embodiments, a speed of at least 21 mph; in other embodiments, a speed of at least 22 mph; in other embodiments, a speed of at least 23 mph; in other embodiments, a speed of at least 24 mph; in other embodiments, a speed of at least 25 mph.

Different features of the different embodiments described herein may be combined in various ways as may be operative. For instance, where plurals shaft are described and depicted, a single shaft may be employed, and vice-versa.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An apparatus comprising:
an elongate shaft;
a mounting structure configured to connect the shaft to an aquatic vehicle; and
a plurality of cutting blades journaled for free rotation on the shaft at coaxial spaced locations along the shaft.

2. The apparatus of claim 1 wherein at least one of the plurality of cutting blades has one or more pitched regions.

3. The apparatus of claim 1 wherein at least one of the plurality of cutting blades is connected to the shaft via a ball bearing journal.

4. The apparatus of claim 1 wherein the mounting structure comprises:
an upper portion configured to connect to the aquatic vehicle;
a lower portion connected to the shaft; and
a hinged joint between the upper and lower portions that permits the lower portion to pivot with respect to the upper portion.

5. The apparatus of claim 4 further comprising a safety member connected to the upper and lower portions and configured to restrict pivoting of the lower portion in an operating condition but permit pivoting of the lower portion in an object striking condition.

6. The apparatus of claim 5 wherein the safety member is selected from the group consisting of a spring and a shearing member.

7. The apparatus of claim 1 further comprising a releasable aquatic vehicle connector.

8. The apparatus of claim 1 wherein the mounting structure comprises:
an upper portion configured to connect to the vehicle;
a lower portion connected to the shaft;
a sleeve configured to slidably receive the upper portion; and
a locking mechanism for locking the upper portion at a predetermined position relative to the sleeve.

9. An apparatus comprising:
a support;
a mounting structure configured to connect the support to an aquatic vehicle;
a plurality of shafts fixed to the support; and
at least one cutting blade journaled for free rotation on each shaft, the at least one cutting blade having at least one cutting edge.

10. The apparatus of claim 9 wherein the support includes a transverse member and the plurality of shafts are fixed to the transverse member along a length of the transverse member, the plurality of shafts extending generally normal to the length of the transverse member.

11. The apparatus of claim 9 comprising two or more cutting blades coaxially mounted on each shaft for free rotation on the shaft.

12. The apparatus of claim 9 wherein each blade is connected to the respective shaft via a ball bearing journal.

13. The apparatus of claim 9 wherein the support comprises a plurality of members.

14. The apparatus of claim 9 wherein the support comprises:
an upper portion configured to connect to the aquatic vehicle;
a lower portion connected to the plurality of shafts; and
a hinged joint between the upper and lower portions that permits the lower portion to pivot with respect to the upper portion.

15. The apparatus of claim 9 wherein the support comprises:
a pair of upper portions configured to connect to the aquatic vehicle;
a pair of lower portions connected to the plurality of shafts; and
a pair of hinged joints between the upper and lower portions that permit the lower portions to pivot with respect to the upper portions.

16. The apparatus of claim 15 further comprising a first safety member associated with one of the hinged joints and a second safety member associated with the other of the hinged joints, the first and second safety members configured to restrict pivoting of the lower portions in an operating condition but permit pivoting of the lower portions in an object striking condition.

17. The apparatus of claim 9 wherein the mounting structure includes a strap configured to releasably engage the aquatic vehicle.

18. An aquatic vehicle comprising:
a hull;
a propulsion system suitable for propelling the hull;
a cutting apparatus operably connected to the hull, the cutting apparatus comprising:
a support;
a mounting structure configured to connect the support to the hull;
a plurality of shafts fixed to the support; and
at least one cutting blade journaled for free rotation on each shaft, the at least one cutting blade having at least one cutting edge.

19. The aquatic vehicle of claim 18 further comprising two or more cutting blades coaxially mounted on each shaft for free rotation on the shaft.

20. The aquatic vehicle of claim 18 further comprising one or more slide connections between the mounting structure and the support; and
a plurality of vertically spaced positions between the mounting structure and the support at which the support can be fixed relative to the mounting structure.

21. The aquatic vehicle of claim 20 further comprising a lift of the cutting apparatus operably connected to the mounting structure and the support for moving the support relative to the mounting structure.

22. The aquatic vehicle of claim 18 wherein the mounting structure includes a strap extending around a portion of the hull.

23. A method of cutting aquatic vegetation, the method comprising:
providing an aquatic vehicle having disposed thereon a cutting device, the cutting device having a shaft with at least one cutting blade journaled for free rotation on the shaft;
positioning the shaft in a body of water that contains aquatic vegetation;
moving the vehicle through the body of water to thereby cause rotation of the cutting blade and cutting of the aquatic vegetation.

24. The method of claim 23 wherein the cutting device includes a plurality of cutting blades.

25. The method of claim 24 wherein a leading cutting blade of the plurality of cutting blades performs initial cutting of the aquatic vegetation and a trailing cutting blade of the plurality of cutting blades performs subsequent cutting of the aquatic vegetation.

26. The method of claim 23 further comprising orienting the shaft to generally extend from a mounting structure toward a bow direction of the aquatic vehicle.

27. The method of claim 23 further comprising providing a second cutting device disposed on the aquatic vehicle, the second cutting device having another elongate shaft with at least one cutting blade rotatably journaled thereon,
wherein moving the vehicle through the body of water includes causing rotation of the at least one cutting blade on both shafts and cutting of the aquatic vegetation.

28. The method of claim 23 further comprising causing the vehicle to be at speeds over ten miles per hour in the body of water while cutting aquatic vegetation.

29. The method of claim 23 further comprising causing the vehicle to be at speeds of at least twelve miles per hour in the body of water while cutting aquatic vegetation.

30. The method of claim 23 further comprising causing the vehicle to be at speeds of at least fifteen miles per hour in the body of water while cutting aquatic vegetation.

31. The method of claim 23 further comprising causing the vehicle to be at speeds of at least twenty miles per hour in the body of water while cutting aquatic vegetation.
